(19) United States
(12) Patent Application Publication
(10) Pub. No.: US 2011/0277379 A1
(43) Pub. Date: Nov. 17, 2011

(54) METHOD AND APPARATUS FOR CAVITATING A MIXTURE OF A FUEL AND AN ADDITIVE

(75) Inventors: Sergey Bortkevitch, Moscow (RU); Alexey Boldyrev, Moscow (RU); Victor Levin, Singapore (SG)

(73) Assignee: Neftech PTE Ltd., Via Jalan Terusan (SG)

(21) Appl. No.: 13/147,125

(22) PCT Filed: Jan. 22, 2010
(86) PCT No.: PCT/SG2010/000019

§ 371 Date: Jul. 29, 2011

(30) Foreign Application Priority Data
Jan. 30, 2009 (SG) 200900680-0

(51) Int. Cl. C10L 1/12; B01F 11/00; C10L 1/10; B01F 5/02

(52) U.S. Cl. 44/457; 366/167.1; 366/108; 44/300

(57) ABSTRACT

An apparatus and a method for cavitating a mixture of a fuel and an additive are disclosed. The apparatus comprises a cavitation stream, the cavitation stream comprising a counter jet device, a jet stroke device and a swirling cavitation device. A mixture of a fuel and additive is arranged to pass through the cavitation stream, wherein the mixture undergoes wave and cavitation processing in the swirling cavitation device. The cavitation apparatus further comprises a resonance chamber and a homogenizer, into which the wave and cavitated mixture is passed to obtain an emulsion of improved homogeneity from an outlet of the homogenizer.

### FIELD OF INVENTION

The present invention relates to a method and apparatus for cavitating a mixture of a fuel and an additive. The invention has particular, but not exclusive, application in production of fuel mixtures for marine engines, power generating facilities and other devices in which liquid fuel is used to create other forms of energy.

### BACKGROUND

Methods and devices have been previously proposed for fuel mixtures which are subjected to cavitation processing, such as for example in Russian Patents 2,221,633, 2,075,619 and 2,115,176. The disadvantage of these methods and respective devices is the low efficiency of the process due to the relatively low vibration frequencies under which the liquid medium is processed.

Also known from Author Certificate USSR 637,138 is a device for emulsion preparation, including fuel emulsions, the device containing a receiver tank, supply pumps, tank-meter, tank for emulsion, hydrodynamic emulator and pipe lines for supply of liquid mediums, emulsifiable component and distribution of emulsion. The disadvantage of the aforesaid device is that upon storage of the emulsion in the tank the emulsion separates which reduces its quality and shortens storage time.

Also known is a prototype method for processing liquid mediums based on the interaction with the obstruction of a liquid jet flowing out of a nozzle at its jogging (surge change of direction), actuation of pressure waves vibrations and cavitation as discussed in Author Certificate USSR 497058.

In this method, processing of the liquid medium is executed by a vibrations generator under the conditions of non-regulated circulation of the liquid medium in the entire volume of mixed medium, random distribution of dispersed component globules and damping of pressure waves at a small distance from the generator.

Therefore, a disadvantage of this method is that, for the qualitative mixing, a large amount of time and energy are required, and it does not guarantee a highly dispersed emulsion.

Also known are devices containing a receiving tank, supply pumps, tank-meter, hydrodynamic emulator, an inlet branch pipe which is connected with an outlet branch pipe of the tank for emulsion such as described in author Certificate USSR 1060212.

The disadvantage of this device is that in the circulation along the closed loop, the regularity of mixing is not ensured due to the concentration of the light component on the surface, and there is no guarantee of pumping through the emulator all volume layers of the mixture.

### SUMMARY

The invention is defined in the independent claims. Some optional features of the invention are defined in the dependent claims.

Implementation of the techniques disclosed herein may result in a highly homogenous activated multi-component mixed fuel produced under wave and cavitation effect on the processed multi-component medium in the regime of non-linear resonance auto oscillations. This may lead to substantial savings of the hydro carbon component of the prepared homogenous fuel, and the use thereof in diesel engines for driving ships, or powering other devices, such as for example in electric power generating plants and other combustion devices.

The aforesaid technical result is achieved due to the fact that in the mixed fuel preparation there is implemented an activation, for example simultaneous activation, of mixed fuel components and their homogenization and processing under cavitation and wave effect in the auto-oscillation regime and circulation of the processed medium through concordantly operating wave hydrodynamic cavitation devices being at the same time generators of pressure wave vibrations. In other words, simultaneous activation and homogenization may occur in any device in which cavitation occurs. Activation can be considered as breaking of long molecular chains in hydrocarbons while homogenization improves the uniformity of the emulsion in terms of the distribution of the fuel and the additive globules.

As the result of wave and cavitation processing, there occurs destruction of disperse inclusions and agglomerates present in high viscosity fuels, such as ship fuels, while hydro stroke and thermal loads, micro flows and cumulative micro-jets cause deep physical-chemical changes in both the fuel carrying liquid and in the added components, such as water for example, in the dispersed phase. This causes tearing of the high-molecular chains, formation of free radicals, electrization, molecular cracking, ionization and etc. Due to thermo-dynamic gaseous processes in the collapsed cavitative bubble, temperature and pressure grow respectively up to the values of more than 10² MPa and 10⁴ K. With the acceleration of the process at non-linear wave processes, the developed cavitation occurs due to the discrete energy distribution in the large number of cavitation centers, and wherein the larger part of the energy is concentrated in the volumes conforming with the size of cavitation bubbles in the range of 1-100 mcm. This drastically intensifies the thermo-mass exchange physical-chemical processes, inclusive of cracking processes, at which high molecular heavy hydrocarbons are partially converted into easy boiling fractions with formation of chemically active free radicals, and processes of thermo-chemical water decomposition with formation of atomic hydrogen.

Summation of the main and secondary effects of wave resonance processes and cavitation effect allows a substantial increase in the efficiency of the process of preparation of mixed fuel with high thermo-physical and consumer properties and upgrades the process of its combustion and ensures substantial saving of the hydrocarbon component in the fuel such as standard ship fuel.

### BRIEF DESCRIPTION OF DRAWINGS

Techniques for cavitating a mixture of a fuel and additive will now be described with respect to the accompanying drawings wherein:

FIG. 1 is a process flow sheet illustrating the overall process of the invention as performed by one preferred system of physical components

FIG. 2 is a more detailed flow sheet, partly in cross-section, illustrating the principal components of the preferred system including a pair of cavitation streams arranged in opposed flow relationship

FIG. 3 is an enlarged cross-sectional view of one of the cavitation streams

FIG. 4 is a cross-sectional view taken along view-line 4-4 of FIG. 3

FIG. 5 is a schematic illustration of the principles of operation of a jet-stroke hydrodynamic oscillator or a jet stroke device

### DETAILED DESCRIPTION

A cavitation apparatus 500 for cavitating a mixture of a fuel and an additive comprises a cavitation stream 2, wherein the cavitation stream comprises a counter jet device 1a, a jet stroke device 1b and a swirling cavitation device 1c and the apparatus is being arranged for the mixture to be passed through the cavitation stream. This arrangement will be discussed in detail below.

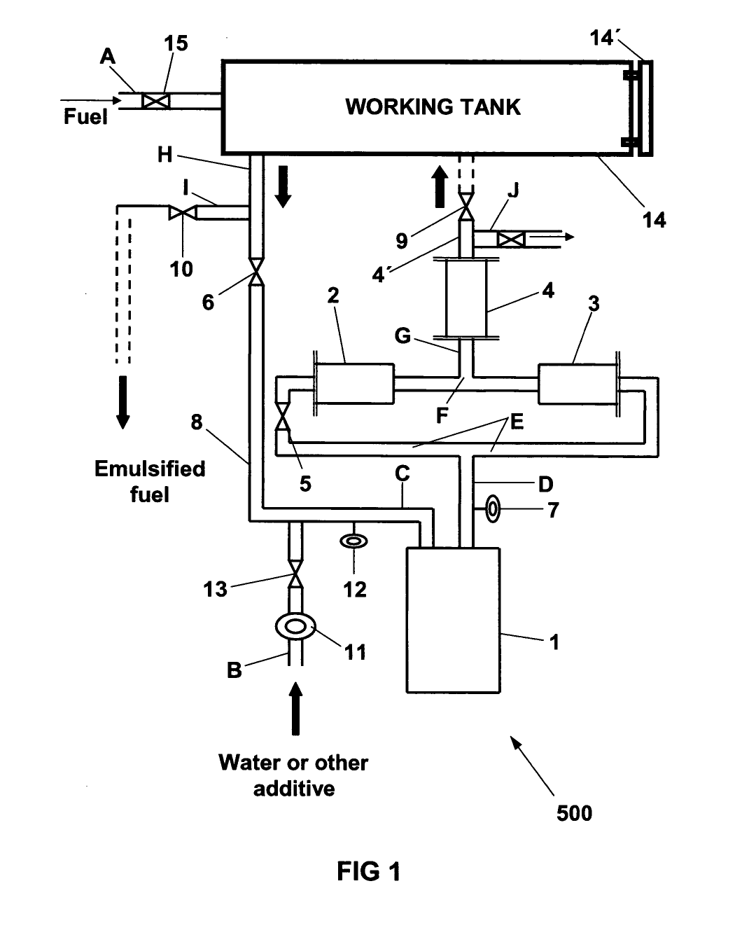

In the example of FIG. 1, the cavitation apparatus 500 further comprises a tank 14, hereinafter referred to as a working tank. In practice such as on a ship, the tank 14 may be one of the fuel storage tanks to which standard liquid fuel is supplied through an inlet line A via a control valve 15. The fuel may be one that is conventionally used for driving ships and engines. However, in the example of FIG. 1, this tank also includes a heater 14′ for heating the liquid therein to a temperature in the range of say 70° C. to 90° C. depending on the rheological properties of the particular fuel. The rheological properties of a fluid are properties like viscosity and elasticity which affect the flow characteristics of a fluid. The purpose of heating and the extent of heating the fuel is to bring the rheological properties of the fuel to a desired value, so as to facilitate a desired mixing of the fuel and an additive. An additive component, for example water, or another additive as described hereafter, enters the system at inlet B and passes through a flow-meter 11 and a regulator valve 13 into line C, containing a vacuum meter 12, and flows into the inlet of a pump 1. The pumping action of the pump 1 also draws the fuel from the working tank, with both the fuel and the additive mixed in their desired proportions.

Pump 1 discharges the mixture of the fuel and the additive through line D, containing a manometer 7, into split branch lines E, where the mixture is divided into multiple streams, and through which the mixture flows to the respective inlet ends of opposed-flow wave cavitation streams 2 and 3. Preferably, a flow-control valve 5 is provided in one or both of branch lines E. The mixture is processed in wave cavitation streams 2 and 3, as will be more fully described hereafter.

The cavitation apparatus further comprises a resonance chamber at point F, and the resonance chamber is arranged to receive the effluent from the cavitation stream 2. Alternatively in the example of FIG. 1, the effluents from the wave cavitation streams 2 and 3 are recombined in a resonance chamber provided at F, from which the joined effluents pass through line G into a static homogenizer 4 to form an emulsion. The working tank 14 is arranged to be in fluid communication with an outlet 4′ of the homogenizer, which enables the emulsion to flow from the outlet 4′ of the homogenizer and through a control valve 9 to the working tank 14. The emulsion of improved homogeneity, then flows through outlets H and I of the working tank, and control valve 10, to one or more ship's diesel engines, or to whatever other combustion device may be desired to be fueled.

Alternatively, the cavitation apparatus further comprises a recycle line 8 between the working tank 14 and the cavitation streams. In the example of FIG. 1, once the system has reached steady state operation, by virtue of recirculation through the recycle line 8 and the rest of the system described above, some or all of the homogenized emulsion in tank 14 may be discharged through line J to the engine or other combustion device. During the recirculation process, fresh fuel or additive may be added to at least a portion of the emulsion to change the proportion of the fuel and the additive in the emulsion as required. In another alternative arrangement, the emulsion from the outlet 4′ of the homogenizer flows directly to the combustion device. In this regard, it will be understood that such recirculation and the overall operation of the process flow is controlled and may be varied by the operation of valves 5, 6, 9, 10 and 13 with the conditions as monitored by manometers 7, 12 and flow-meter 11.

The emulsion before being supplied to the combustion device such as a ship or an engine may be heated depending on the requirement. The emulsion provided to the combustion device is an emulsion of improved homogeneity.

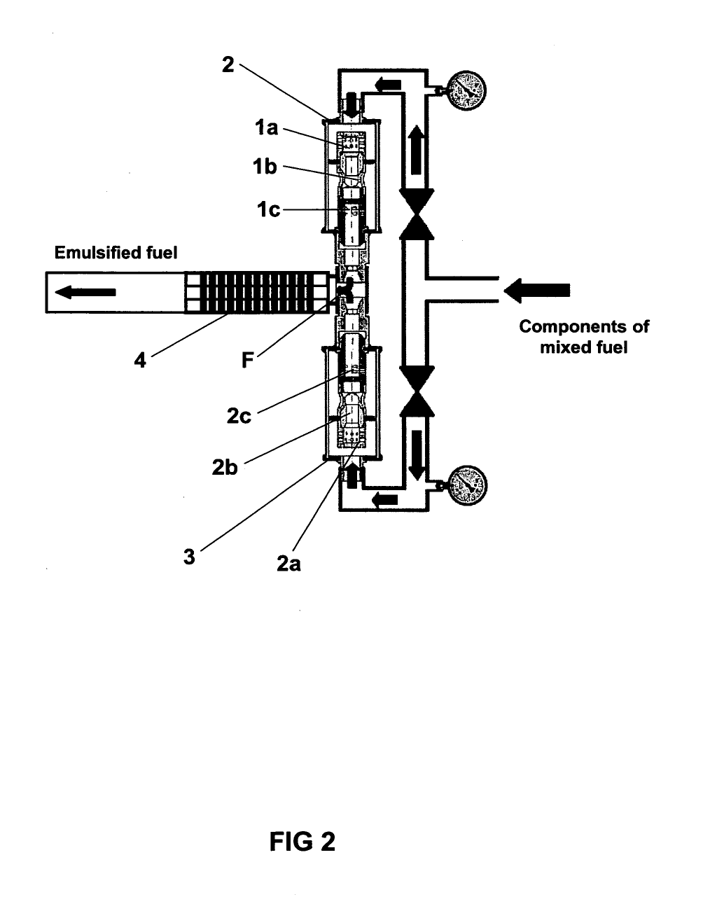

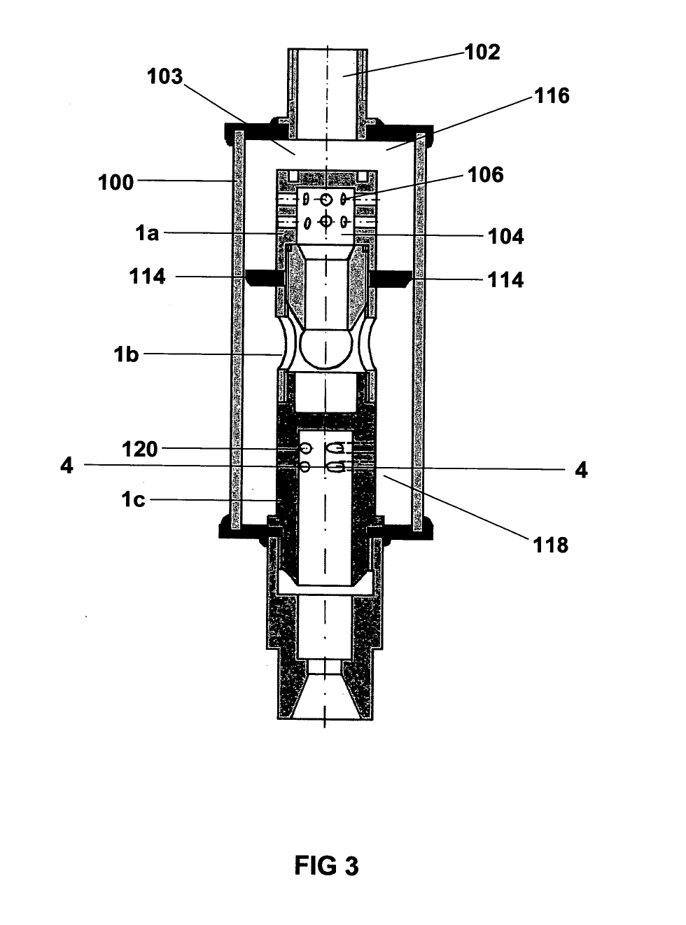

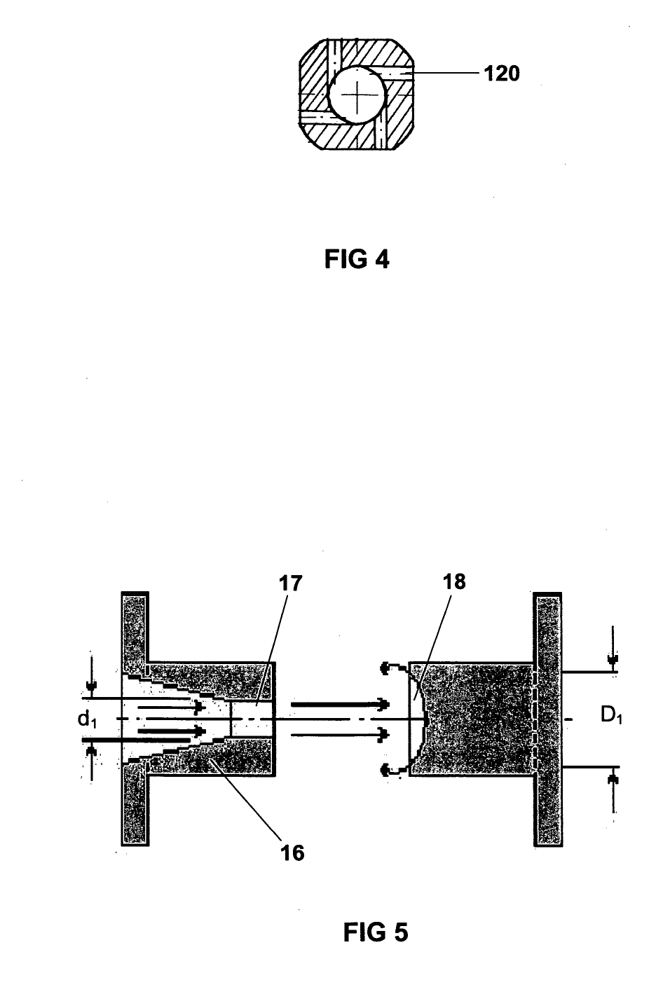

A more detailed description of the operation of cavitation streams 2 and 3, as well as the overall process, will now be described with reference to FIGS. 2 to 5. As illustrated in FIG. 3, the cavitation stream 2 comprises an outer liquid proof casing 100. An inlet 102 enables introduction of the mixture of the fuel and the additive into the cavitation stream 2. The mixture initially enters the counter jet device la from a clearance 103 between the casing and the counter jet device. The counter jet device la has a cavity 104 and, in this example, multiple inlets 106. The mixture enters the cavity 104 through the inlets 106, the inlets enabling the formation of jet streams as the mixture flows through the inlets. In the counter jet device, the inlets are arranged in a manner such that the jets are formed opposite each other enabling creation of turbulence inside the cavity. This turbulence causes cavitation bubbles to appear and collapse. The main purpose of the counter jet device is the homogenizing of the processed mixture and preliminary cracking of the additive globules. The above construction and working is applicable to the counter jet device 1b as well.

In the example of FIG. 3, the counter jet device is fitted to a jet stroke device 1b. The jet stroke devices are also referred to as jet shock wave oscillators which convert a part of the energy of a turbulent submerged jet into the energy of acoustic waves as the mixed liquid jet flows out from a nozzle against an obstruction of a certain form and size. In this example, the obstruction is the reflector portion. The disturbances or perturbations produce a reverse effect on the jet creating an auto oscillation regime due to pulsations in the cavitation area formed between the nozzle and the obstruction. As illustrated in FIG. 5, numeral 16 represents a conical cylinder nozzle having a jet outlet 17, and numeral 18 represents the obstruction-reflector. In the example of FIG. 5, the form of the reflector is in the shape of a cup ensuring formation of a cavitation area, the contents of which with certain frequency is thrown out from the nozzle reflector zone. The reflector portion comprises of a curved surface, and may be concave, convex, hemispherical, conical, cylindrical, ellipsoidal, elliptical or hyperbolic. For excitation of intensive vibrations, a preferred condition is as follows:

1≦D₁/d₁≦6

where D1 is the reflector diameter and d1 is the diameter of the nozzle. The above range provides a suitable condition for cavitation to occur. Cavitation occurs in the jet stroke device due to pressure loss resulting from turbulence when the mixture is thrown from the nozzle to the reflector portion. This enables a cavitation area of toroidal form formed between the faces of the nozzle and the reflector portion. In other words, the flow of fluid has the shape of a donut, with cavitation occurring on the axis of a cross-sectional area of such a donut. The preferred speed of liquid flow in the jet stroke device is around 20-30 m/s and the pressure is around 0.2-1.0 MPa. The frequency range of the generated vibrations is 0.3-25 kHz. The cavitation process in the jet stroke device involves appearance and avalanche like growth of steam bubbles and contained in liquid gas micro bubbles with a size of around 10⁻⁹ mm. The collapsing of cavitation bubbles is not symmetric and is accompanied by formation of cumulative micro jet strokes.

Accordingly, the jet stroke device increases the efficiency of the cavitation streams 2 and 3 with no moving or rotating elements or parts which would subject the device to wear and tear, and require replacement.

The above construction and working is applicable to the jet stroke device 2b as well.

The casing 100 has a partition 114 which extends radially from the external circular surface of the jet stroke device 1b to the circular inner wall of the casing 100, thus providing a liquid proof separation between an upper portion 116 and a lower portion 118 of the internal volume of the casing 100. This is to prevent the fuel entering the casing through the inlet 102 to enter a swirling cavitation chamber 1c directly, without passing through the counter jet device la and jet stroke device 1b. This is discussed in more detail below.

As illustrated in FIG. 3, the mixture exiting the jet stroke device 1b now enters the swirling cavitation chamber 1c through the inlets 120. It is known in the art for inlets 120 to be tangential inlets, which produces a swirling flow of the mixture in the cavity of the swirling cavitation device. The swirling flow induces wave and cavitation effect in an auto oscillation regime which is explained below.

Auto oscillations are non-damped oscillation occurring in non-linear systems, whose amplitude and frequency remain constant during a long period of time and are independent of the initial conditions. The auto oscillation regime exists in the swirling cavitation device where the natural frequency and the auto oscillation frequency are the same. Due to the non-damped nature of the oscillations, the ensuing vibrations of the globules of the fuel and the additive cause collapsing of the cavitation bubbles resulting in intense cavitation. The frequency of the pressure waves in the swirling cavitation device can be in the range of, say, a few hundred Hz to, say, 50000 Hz.

In the example of FIG. 3, the counter jet device, jet stroke device and the swirling cavitation device are provided in a sequential arrangement which enables a joint coordinated operation of all three devices producing a synergistic effect, which is explained below.

The intensity of cavitation of the jet stroke device is greater than that of the counter jet device, which results from a corresponding relationship with the turbulence in each of the devices.

Similarly, the intensity of cavitation of the swirling cavitation device is greater than that of the jet stroke device, which again results from a corresponding relationship with the turbulence in each of the devices. The frequency of pressure waves involved in the cavitation process also increases gradually from the counter jet device through the jet stroke device to the swirling cavitation device. If the intensity of cavitation increases, the globule sizes of the components of the mixture decreases. A smaller globule size is preferable in the techniques disclosed herein. Moreover, the cavitation and the reduction in the globule size that occurs in the counter jet device serves as a preparatory stage for the cavitation and the reduction in the globule size that occurs in the jet stroke device. Similarly, the cavitation and the reduction in the globule size that occurs in the jet stroke device serves as a preparatory stage for the cavitation and the reduction in the globule size that occurs in the swirling cavitation device. A technical advantage of this arrangement is that the intensity of cavitation increases gradually thus providing a more efficient breakdown of globules into smaller units.

The process described above happens in the cavitation stream 3 of FIG. 1 as well.

The cavitation stream may follow a different order in the arrangement of the counter jet device, jet stroke device and the swirling cavitation device. This order may be dependent on the viscosity of any one of the fuel, additive and the mixture of the fuel and additive or the hydrostatic pressure involved in the cavitation apparatus.

Thus, the fuel additive mixture is subjected to wave and cavitation processing as described above before entering the resonance chamber at F having parameters conforming with the amplitude-frequency characteristics of cavitation streams 2 and 3. In other words, any system or chamber has a resonant frequency, which is the frequency at which resonance occurs. Resonance is defined as the tendency of the system to oscillate at larger amplitude at some frequencies than at others, the frequencies being the resonant frequencies. Generally the resonant frequency of the system is dependent on the shape and/or volume of the system.

In the present example, the resonance chamber provided at F is designed such that by selecting suitable parameters like length and diameter, the resonance chamber may be arranged to have a resonant frequency with respect to a frequency characteristic of the cavitation stream. The frequency characteristic of the cavitation stream may be defined as the frequency of the pressure waves involved in the process of cavitation in the devices of the cavitation streams 2 and 3, and preferably the frequency of pressure waves of the effluent coming out of the cavitation stream. The technical advantage of this arrangement is to effect resonance in the resonance chamber.

The valve 5 may be provided on both branches of line E so that the flow of the mixture of the fuel and the additive through the cavitation streams 2 and 3 is arranged to follow the below pattern:

Q=Q₀sinωt

wherein Q₀ is the maximum flow rate through each cavitation stream 2 or 3, ω is the eigen angular frequency of resonance chamber and t is the time. The technical advantage of the above flow condition is to enable generation of resonance phenomenon inside chamber F.

The above flow condition also provides the above advantage in the event of having a single cavitation stream in the cavitation apparatus, where Q and Q₀ respectively are the flow rate and maximum flow rate through the cavitation stream.

As described above, the effluent from the resonance chamber at F is arranged to enter the homogenizer 4. A homogenizer is used to form a composition of improved uniformity of all the components present in the effluent resulting in an emulsion.

Accordingly, the initial fuel additive mixture is subjected to one or more of the previously described processing conditions including pressure wave vibrations, destruction of disperse inclusions, deep physical-chemical changes including tearing of high-molecular chains, formation of free radicals, electrization, molecular, cracking, ionization and thermo-chemical water decomposition with the formation of atomic hydrogen all as previously described.

The cavitation apparatus is arranged such that the mixture of the fuel and the additive is arranged to flow through the swirling cavitation device at a flow rate selected with respect to an inlet property of the swirling cavitation device. Preferably, the above processing and preparation of mixture of the fuel and the additive is executed at flow of liquid phase Q₁ (m³/sec) through each of swirling cavitation devices, shown most clearly in FIG. 3, according to the equation:

5d²≦Q₁≦70d²,

where d—equivalent diameter of the inlet channel (m), d=\sqrt{4S/π}, where S—sum of cross sectional area of one or more tangential inlet channels d of the swirling cavitation device (m²), π=3.1415. The technical advantage provided by the above condition is to facilitate achieving an optimum globule size, which results in an emulsion of improved homogeneity.

The cavitation apparatus is arranged such that an internal diameter of the counter jet device is selected with respect to an inlet property of the counter jet device. Preferably, the relationships between the inlets in the counter jet portion and its internal diameter is described by the following formulae:

D₂>d₂√n

where D₂ is the internal diameter of the counter jet portion, d₂ is the equivalent inlet diameter of the counter jet portion and n is the number of inlets of the counter jet device. d₂=√(4S/π), where S is the sum of the cross sectional areas of one or more inlets of the counter jet device.

The relationship between the equivalent diameter d of inlets of the swirling cavitation device and equivalent diameter d₂ of the counter jet device is described by the following formula:

d<0.6/0.99d₂

The technical advantage of this condition is to provide optimum conditions for maintenance of turbulence in the cavitation stream.

The emulsion exiting the homogenizer is an improved homogenized emulsion of fuel and the preferred additive, such as water, whereby it has been evaluated that substantially greater energy may be produced from a given volume of standard fuel conventionally supplied to ships engines, or other fuels presently used for combustion engines of all types, and particularly for the generation of electrical power such as in steam driven electrical power generation plants for example.

As a result of all of the above, the activation of water under cavitation and wave effect in the regime of non-linear resonance considerably increases the eventual saving of the hydrocarbon component, and the joint concordant usage of a few variants of hydrodynamic devices of different operational principle, as described in the proposed invention, results in a synergistic effect which increases the eventual fuel savings. Also the processing of the prepared mixed fuel components in the regime of non-liner resonance effect substantially reduces the energy expenditures for the process. In addition, the design the block of hydrodynamic blocks produces an integrated unit, which does not contain rotating or moving components or electric chains which ensures high reliability, long service life and absence of the necessity for maintenance servicing during the exploitation period.

With respect to the additive component to be mixed with the fuel, water is the preferred additive for most applications as previously stated. However, the present invention is not limited to the use of water as the additive may be other liquid mediums, highly dispersed powder components, and gases. Alternately, the additive may be a compound that contains hydrogen and oxygen apart from other elements. Moreover, the additive may be a compound comprising hydrocarbons.

All the individual devices mentioned above are capable of simultaneous activation and homogenization. In other words, simultaneous activation and homogenization may occur in any device in which cavitation occurs. Activation can be considered as breaking of long molecular chains in hydrocarbons while homogenization improves the uniformity of the emulsion in terms of the distribution of the fuel and additive globules.

Accordingly, it is to be understood that the foregoing description of one preferred embodiment of the present invention is intended to be purely illustrative of the principles of the invention, rather than exhaustive thereof, and that changes and variation will be apparent to those skilled in the art, and that the present invention is not intended to be limited other than as expressly set forth in the following claims.

1. A cavitation apparatus for cavitating a mixture of a fuel and an additive, the apparatus comprising a cavitation stream, the cavitation stream comprising a counter jet device, a jet stroke device and a swirling cavitation device, the apparatus being arranged for the mixture to be passed through the cavitation stream.

2. The apparatus as claimed in claim 1, further including a resonance chamber arranged to receive an effluent from the cavitation stream.

3. The apparatus as claimed in claim 2, arranged for the mixture of the fuel and the additive to flow through the cavitation stream at a flow rate selected to produce resonance phenomenon inside the resonance chamber.

4. The apparatus as claimed in claim 2, wherein the resonance chamber is arranged to have a resonant frequency selected with respect to a frequency characteristic of the cavitation stream.

5. The apparatus as claimed in claim 1, wherein the apparatus is arranged for the mixture to flow through the swirling cavitation device at a flow rate selected with respect to an inlet property of the swirling cavitation device.

6. The apparatus of claim 5, wherein the inlet property is derived from a sum of cross sectional areas of one or more inlets of the swirling cavitation device.

7. The apparatus as claimed in claim 1, wherein an internal diameter of the counter jet device is selected with respect to an inlet property of the counter jet device.

8. The apparatus as claimed in claim 7, wherein the inlet property is derived from a sum of cross sectional areas of one or more inlets of the counter jet device and a number of inlets of the counter jet device.

9. The apparatus as claimed in claim 1, comprising a homogenizer arranged to receive the effluent of the fuel and the additive from the resonance chamber.

10. The apparatus as claimed in claim 9, further including a working tank in fluid communication with an outlet of the homogenizer and an outlet from the working tank for passing the emulsion to a combustion device.

11. The apparatus as claimed in claim 9, wherein the apparatus is arranged for passing the emulsion from the outlet of the homogenizer to the combustion device.

12. The apparatus as claimed in claim 10, further comprising a recycle line between the working tank and the cavitation stream.

13. The apparatus as claimed in claim 1, wherein the apparatus comprises multiple cavitation streams.

14. A method of cavitating a mixture of a fuel and an additive, the method comprising passing the mixture through a cavitation stream, the cavitation stream comprising a counter jet device, a jet stroke device and a swirling cavitation device.

15. The method as claimed in claim 14, wherein the additive contains hydrogen and oxygen.

16. The method as claimed in claim 14, wherein the additive is water.

17. The method as claimed in claim 14, wherein the fuel is a fuel conventionally used for driving ships and engines.

18. The method as claimed in claim 14, wherein the method comprises passing the mixture through a resonance chamber from an outlet of the cavitation stream.

19. The method as claimed in claim 18, wherein the method comprises passing an effluent through a homogenizer from an outlet of the resonance chamber, to form an emulsion of the fuel and the additive.

20. The method as claimed in claim 19, wherein the emulsion is supplied to one or more ships engines.

21. The method as claimed in claim 14, wherein the mixture is also heated before use as the emulsion for combustion.

22. The method as claimed in claim 19, wherein at least a portion of the emulsion is recycled with fresh fuel before being used as a fuel.

23. The method as claimed in claim 14, wherein during cavitating the mixture of the fuel and the additive, the mixture is subjected to any one of destruction of inclusions, tearing of physical-chemical changes, formation of free radicals, electrisation, molecular cracking, ionization, formation of atomic hydrogen and electrolytic substitution.

24. The method as claimed in claim 14, wherein the mixture is subjected to the steps of:
(a) dividing the mixture into multiple streams and subjecting each of the streams into cavitation and wave processing separately; and
(b) recombining the multiple streams.

25. The method as claimed in claim 24, wherein the recombining is performed in the resonance chamber.

26. The method of any claim 14, wherein the passing the mixture through the swirling cavitation device is in accordance with the inequality
5d²≦Q₁≦70d²
where d—equivalent diameter of the inlet channel (m), d=\sqrt{4S/π}, S—total cross sectional area of all inlet tangential channels d (m²), Q₁ is the flow rate (m³/s) through the swirling cavitation device and π=3.1415.

27. The method of cavitating a mixture of a fuel and an additive using the apparatus of claim 1.
